(19) United States
(12) Patent Application Publication
(10) Pub. No.: US 2026/0118126 A1
(43) Pub. Date: Apr. 30, 2026

(54) DESIGN METHOD FOR ALL-FUSED-SILICA CAPACITIVE PLANARIZED MICRO ELECTRO-MECHANICAL SYSTEMS (MEMS) GYROSCOPE

(71) Applicant: NATIONAL UNIVERSITY OF DEFENSE TECHNOLOGY, Changsha (CN)

(72) Inventors: Dingbang XIAO, Changsha (CN); Xinyu WANG, Changsha (CN); Qingsong LI, Changsha (CN); Xuezhong WU, Changsha (CN); Yan SHI, Changsha (CN); Zhanqiang HOU, Changsha (CN); Xiang XI, Changsha (CN); Yongmeng ZHANG, Changsha (CN); Jiangkun SUN, Changsha (CN)

(73) Assignee: NATIONAL UNIVERSITY OF DEFENSE TECHNOLOGY, Changsha (CN)

(21) Appl. No.: 19/344,606

(22) Filed: Sep. 30, 2025

(30) Foreign Application Priority Data
Oct. 29, 2024 (CN) 202411521876.0

(51) Int. Cl. G01C 19/5712

(52) U.S. Cl. CPC G01C 19/5712

(57) ABSTRACT

The provided is a design method for all-fused-silica capacitive planarized micro electro-mechanical systems (MEMS) gyroscope, including: determining a configuration of the MEMS gyroscope, including a substrate and a structural layer, the structural layer being a planar structure; forming a recess at one side of the substrate, and providing a boss in a center of the recess; on the structural layer, integrally forming a central anchor point, a support beam, a resonant ring, fixed electrodes, and a peripheral anchor point region in sequence from the center outward; forming a capacitive gap having a high-steepness structural sidewall and a high-aspect ratio between the resonant ring and each of the fixed electrodes; when the substrate and the structural layer are assembled, fixing the boss to the central anchor point, fixing a recess periphery to the peripheral anchor point region, and suspending the support beam and the resonant ring on the recess.

### CROSS-REFERENCE TO THE RELATED APPLICATIONS

This application is based upon and claims priority to Chinese Patent Application No. 202411521876.0, filed on Oct. 29, 2024, the entire contents of which are incorporated herein by reference.

### TECHNICAL FIELD

The present disclosure relates to the technical field of micro electro-mechanical systems (MEMS), and in particular to a design method for all-fused-silica capacitive planarized MEMS gyroscope.

### BACKGROUND

Gyroscopes are sensors that are used to measure angles or angular velocities of moving carriers relative to an inertial space. They serve as essential components in inertial navigation systems. MEMS gyroscopes have emerged since the 1980s. Compared with optical gyroscopes and conventional mechanical rotor gyroscopes, the MEMS gyroscopes feature small size, low power consumption, mass producibility, and ease of integration, yielding broad application prospects.

Based on the well-established semiconductor industry, silicon was initially adopted as a material to fabricate the MEMS gyroscopes. However, due to anisotropy, susceptibility to impurity defects, high thermoelastic damping, and other limitations, the single-crystal silicon falls short of meeting future development requirements of the MEMS gyroscopes. Hence, high-quality fused silica has emerged as an ideal material for fabrication of the MEMS gyroscopes.

Research on fused silica based MEMS hemispherical gyroscopes has demonstrated that the new material significantly improves the accuracy of the gyroscopes. However, the fabrication processes of the MEMS hemispherical structure are incompatible with the conventional planarized MEMS processes, and difficult to achieve wafer-level fabrication like existing MEMS gyroscope products.

### SUMMARY

In view of the above technical problem, it is necessary to provide a design method for all-fused-silica capacitive planarized MEMS gyroscope, to realize the planarized design, and effectively improve the accuracy of the MEMS gyroscope.

A design method for all-fused-silica capacitive planarized MEMS gyroscope is applied to design a structure of an MEMS gyroscope, and includes: determining a configuration of the MEMS gyroscope, including a substrate and a structural layer, the structural layer being a planar structure;
forming a recess at one side of the substrate, and providing a boss in a center of the recess;
on the structural layer, providing a central anchor point, a support beam, a resonant ring, fixed electrodes, and a peripheral anchor point region in sequence from the center outward, where the central anchor point, the support beam, the resonant ring, the fixed electrodes and the peripheral anchor point region are integrally formed; and forming a capacitive gap having a high-steepness structural sidewall and a high-aspect ratio between the resonant ring and each of the fixed electrodes;
when the substrate and the structural layer are assembled, fixing the boss to the central anchor point, fixing a recess periphery to the peripheral anchor point region, and suspending the support beam and the resonant ring on the recess; and
upon completion of assembly, depositing a conductive film layer on the resonant ring, the support beam and the fixed electrodes by atomic layer deposition (ALD), and segmenting the conductive film layer to form effective capacitors.

According to the design method for all-fused-silica capacitive planarized MEMS gyroscope, the structural layer is the planar structure, so the overall fabrication process is simpler. The central anchor point, the support beam, the resonant ring, the fixed electrodes and the peripheral anchor point region are integrally formed, decreasing junctions between assemblies and potential weak points, reducing the stress concentration, improving the accuracy and consistency of the whole MEMS gyroscope, and further lowering the production difficulty and the cost. The capacitive gap having a high-steepness structural sidewall and a high-aspect ratio is formed between the resonant ring and the fixed electrode, which can better improve the sensitivity of the capacitor, ensuring the detection accuracy on change in capacitance, and improving the detection sensitivity and response speed of the MEMS gyroscope. In addition, the conductive film layer is deposited on the resonant ring, the support beam and the fixed electrodes by the ALD, such that the thickness of the capacitor layer can be ensured to be uniform and consistent, improving the accuracy for detecting the capacitance and the overall performance of the MEMS gyroscope. By segmenting the deposited conductive film layer, the high-quality capacitor layer is formed. The design method provided by the present disclosure has advantages of mass producibility and low cost, can realize wafer-level mass production, and yields a broad application prospect.

### BRIEF DESCRIPTION OF THE DRAWINGS

To describe the technical solutions in the embodiments of the present disclosure or in the prior art more clearly, the following briefly describes the accompanying drawings required for describing the embodiments or the prior art. Apparently, the accompanying drawings in the following description show merely some embodiments of the present disclosure, and those skilled in the art may still derive other drawings from these accompanying drawings without creative efforts.

FIG. 1 is an axonometric view of a gyroscope according to an embodiment;

FIG. 2 is a sectional view of a gyroscope according to an embodiment;

FIG. 3 is an axonometric view in which a resonant ring is connected to a central anchor point according to an embodiment;

FIG. 4 is an axonometric view of a first design for fixed electrodes according to an embodiment;

FIG. 5 is an axonometric view of a second design for fixed electrodes according to an embodiment;

FIG. 6 is an axonometric view of a substrate according to an embodiment;

FIG. 7 is a schematic flowchart of fabrication and assembly processes of a gyroscope according to an embodiment; and

FIG. 8 is a schematic view of a fused silica wafer including a plurality of gyroscopes according to an embodiment.

### REFERENCE NUMERALS

1: substrate, 11: recess, 12: boss, 13: recess periphery, 2: structural layer, 21: central anchor point, 22: support beam, 23: resonant ring, 24: fixed electrode, 241: separation groove, 25: conductive film layer, 26: capacitive gap, 27: peripheral anchor point region, 31: structural layer wafer, and 32: substrate layer wafer.

The implementation of the objectives, functional characteristics and advantages of the present disclosure will be further described below with reference to the embodiments and the drawings.

### DETAILED DESCRIPTION OF THE EMBODIMENTS

The following clearly and completely describes the technical solutions in the examples of the present disclosure with reference to the accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure. All other embodiments obtained by a person of ordinary skill in the art based on the examples of the present disclosure without creative efforts shall fall within the protection scope of the present disclosure.

It should be noted that all the directional indications (such as upper, lower, left, right, front, and rear) in the embodiments of the present disclosure are merely used to explain relative position relationships, motion situations, and the like of the components in a specific gesture (as shown in the figures). If the specific gesture changes, the directional indication also changes accordingly.

Moreover, in the present disclosure, descriptions related to the terms such as “first” and “second” are only for the purpose of description and cannot be understood as indicating or implying relative importance, or implicitly indicating the number of the indicated technical features. Therefore, features defined by “first” and “second” may explicitly or implicitly include at least one of the features. In the descriptions about the present disclosure, “a plurality of” means at least two, for example, two or three, unless otherwise specifically limited.

In the present disclosure, unless otherwise clearly specified and limited, meanings of terms “connection”, “fastening”, and the like should be understood in a board sense. For example, “connection” may be a fixed connection, a removable connection, or integration; may be a mechanical connection or an electrical connection; may be a direct connection or an indirect connection implemented by using an intermediate medium; or may be intercommunication between two components or an interaction relationship between two components, unless otherwise clearly limited. Those of ordinary skill in the art may understand specific meanings of the above terms in the present disclosure based on a specific situation.

Furthermore, the technical solutions between the various embodiments of the present disclosure may be combined with each other, but must be on the basis that the combination thereof can be implemented by those of ordinary skill in the art. In case of a contradiction with the combination of the technical solutions or a failure to implement the combination, it should be considered that the combination of the technical solutions does not exist, and is not within the protection scope of the present disclosure.

The implementations of the present disclosure are described in detail below in combination with the drawings in the embodiments of the present disclosure.

### Embodiment 1

The embodiment provides a design method for all-fused-silica capacitive planarized MEMS gyroscope, which is mainly used to design a structure of an MEMS gyroscope. First of all, the structural layer 2 is the planar structure, so the overall fabrication process is simpler. Then, the central anchor point 21, the support beam 22, the resonant ring 23, the fixed electrodes 24 and the peripheral anchor point region 27 are integrally formed, decreasing junctions between assemblies and potential weak points, reducing the stress concentration, improving the accuracy and consistency of the whole MEMS gyroscope, and further lowering the production difficulty and the cost. The capacitive gap having a high-steepness structural sidewall and a high-aspect ratio is formed between the resonant ring 23 and the fixed electrode 24, which can better improve the sensitivity of the capacitor, ensuring the detection accuracy on change in capacitance, and improving the detection sensitivity and response speed of the MEMS gyroscope. At last, the conductive film layer is deposited on the resonant ring 23, the support beam 22 and the fixed electrodes 24 by the ALD, such that the thickness of the capacitor layer can be ensured to be uniform and consistent, improving the accuracy for detecting the capacitance and the overall performance of the MEMS gyroscope. By segmenting the deposited conductive film layer, the high-quality capacitor layer is formed. The design method provided by the present disclosure has advantages of mass producibility, low cost and high accuracy, can realize wafer-level mass production, and yields a broad application prospect.

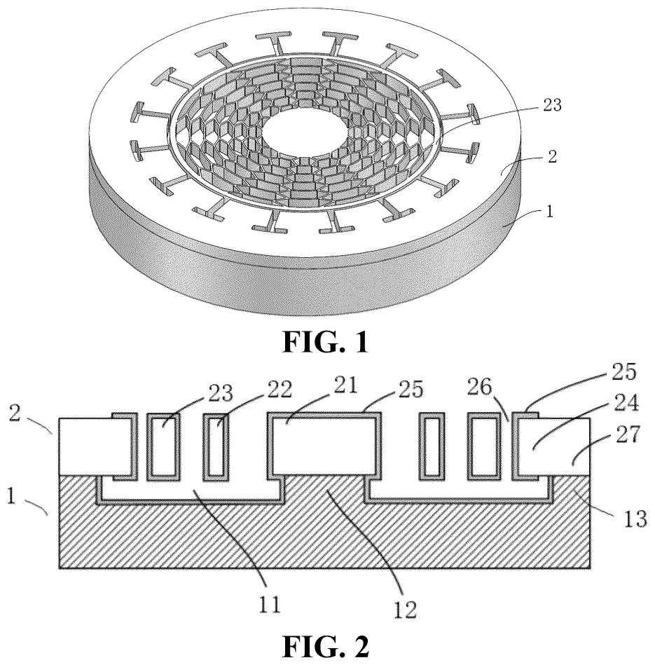

The design method for all-fused-silica capacitive planarized MEMS gyroscope provided by the embodiment is mainly used to design the structure of the MEMS gyroscope. FIGS. 1-6 illustrate a structural design of the MEMS gyroscope in the embodiment. First of all, a configuration of the MEMS gyroscope is determined. The MEMS gyroscope includes substrate 1 and structural layer 2. The structural layer 2 is a planar structure. Recess 11 is formed at one side of the substrate 1. Boss 12 is provided in a center of the recess 11. On the structural layer 2, central anchor point 21, support beam 22, resonant ring 23, fixed electrodes 24, and peripheral anchor point region 27 are provided in sequence from the center outward. The central anchor point 21, the support beam 22, the resonant ring 23, the fixed electrodes 24 and the peripheral anchor point region 27 are integrally formed. A capacitive gap 26 having a high-steepness structural sidewall and a high-aspect ratio is formed between the resonant ring 23 and each of the fixed electrodes 24. When the substrate 1 and the structural layer 2 are assembled, the boss 12 is fixed to the central anchor point 21, recess periphery 13 is fixed to the peripheral anchor point region 27, and the support beam 22 and the resonant ring 23 are suspended on the recess 11. Upon completion of assembly, conductive film layer 25 is deposited on the resonant ring 23, the support beam 22 and the fixed electrodes 24 by ALD. The conductive film layer 25 is segmented to form effective capacitors.

During specific implementation, the substrate 1 and the structural layer 2 are selected. The substrate 1 and the structural layer 2 are the same in shape and size, but differ in: The substrate 1 is a thick planar structure, so as to form the recess. The structural layer 2 is a thin planar structure to facilitate etching. Both the substrate 1 and the structural layer 2 are made of fused silica. This can ensure that each structure deforms consistently, prevent mismatch in coefficient of thermal expansion, improve the quality factor and accuracy of the MEMS gyroscope, and promote the performance of the MEMS gyroscope.

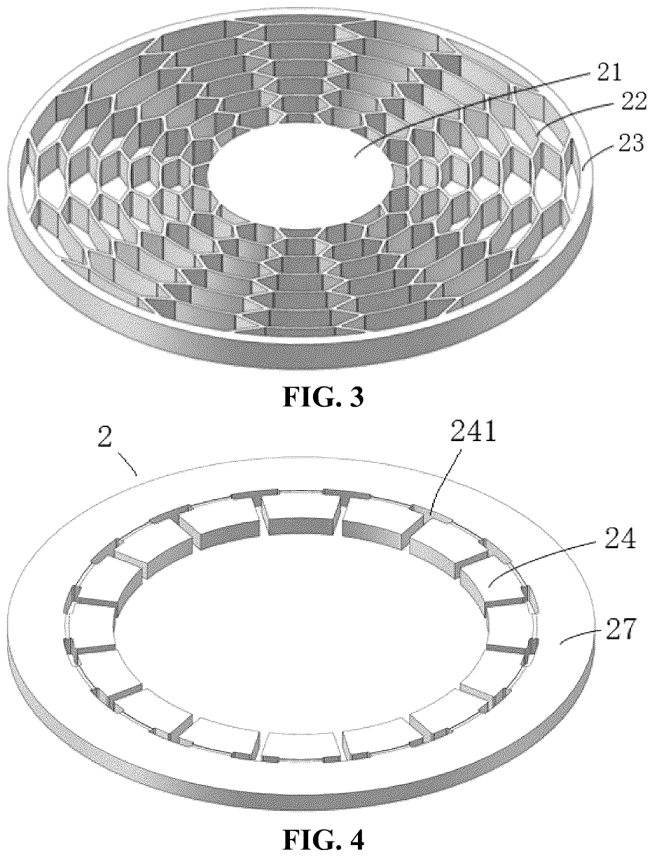

FIG. 3 is a schematic view in which the resonant ring 23 is connected to the central anchor point 21. The central anchor point 21 is circular. The resonant ring 23 is an annular structure sleeved on the central anchor point 21 at intervals. The resonant ring 23 is connected to the central anchor point 21 through the support beam 22. The support beam 22 is a honeycomb-like topological support beam. The honeycomb-like topological support beam can effectively reduce the radial stiffness of the resonant ring, thereby reducing a desired maximum driving voltage. Meanwhile, the combined design for the central anchor point 21, the honeycomb-like topological support beam and the resonant ring 23 can ensure the normal stiffness, inhibit the out-of-plane modal component of the gyroscope, reduce the energy dissipation, and improve the overall performance. It is to be noted that shapes of the central anchor point 21 and the resonant ring 23 may further be provided as required, and are not limited to the shapes shown in the embodiment.

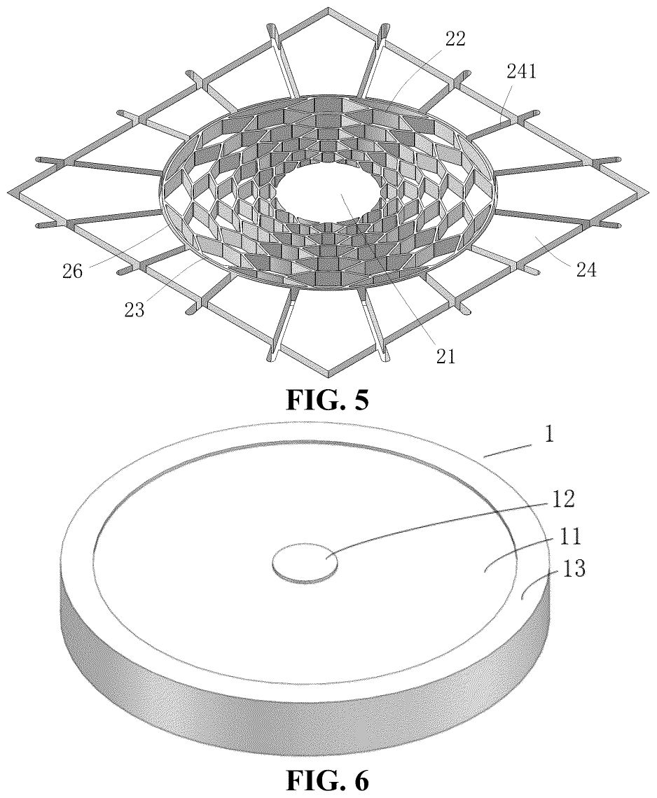

FIG. 4 illustrates a design for the fixed electrodes 24. The fixed electrodes 24 are circumferentially disposed at a periphery of the resonant ring 23 at intervals. A sidewall at one end of each of the fixed electrodes 24 is adjacent to the resonant ring 23. The capacitive gap 26 having the high-steepness structural sidewall and the high-aspect ratio is formed between the fixed electrode 24 and the resonant ring 23. A sidewall at the other end of the fixed electrode 24 is close to the peripheral anchor point region 27. It is to be noted that the fixed electrode 24 may be in a semi-connected state with the peripheral anchor point region 27, as shown in FIG. 4. The fixed electrodes 24 are separated by separation groove 241. The separation groove is wider than the capacitive gap, which can prevent a large diameter of a laser spot, and realize scanning segmentation of femtosecond laser on the conductive film layer. The separation groove 241 may be shaped according to a situation, and is a “T”-shaped groove in the embodiment. As shown in FIG. 5, the fixed electrodes 24 may also be separated completely by dicing. This can prevent the problem that the side conductive film layer cannot be segmented completely for process factors.

It is to be noted that the fixed electrodes 24 in FIG. 4 and FIG. 5 are integrally formed with other structures on the structural layer 2. Regarding the structure for the fixed electrodes 24 in FIG. 4, the central anchor point 21, the support beam 22, the resonant ring 23, the fixed electrodes 24 and the peripheral anchor point region 27 are directly and integrally formed on the structural layer 2 by laser-assisted wet etching. Regarding the structure for the fixed electrodes 24 in FIG. 5, the central anchor point 21, the support beam 22, the resonant ring 23, the fixed electrodes 24 and the peripheral anchor point region 27 are integrally formed on the structural layer 2 by laser-assisted wet etching. Then, the fixed electrodes 24 are diced by stealth dicing, so as to completely separate the fixed electrodes 24, thereby realizing independent distribution for a plurality of fixed electrodes.

It is to be understood that the capacitive gap 26 having the high-steepness structural sidewall and the high-aspect ratio formed between the resonant ring 23 and the fixed electrode 24 can increase the variation in capacitance, and reduce the parasitic effect in an electric field. Moreover, with integral fabrication, the dimensional error caused by processes such as separate fabrication followed by assembly can be reduced, each element is ensured to have the same capacitance, and the mechanical stability of the microstructure is enhanced, improving the consistency for devices and the yield in mass production.

Referring to FIG. 6, the substrate 1 is a planar structure with a certain thickness. The recess 11 with the boss 12 in the center is formed at one side of the planar substrate 1. The recess 11 matches with the resonant ring 23 in shape, ensuring that the resonant ring 23 can be suspended. In assembly, the substrate 1 and the formed structural layer 2 are coaxially laminated. The central anchor point 21 is coaxially fixed on the boss 12. A peripheral region of the central anchor point 21 is suspended on the recess 11. The support beam 22 and the resonant ring 23 are completely suspended on the recess 11. A region of the fixed electrode 24 close to the resonant ring 23 is suspended on the recess 11, and a region of the fixed electrode 24 away from the resonant ring 23 is coaxially fixed on the peripheral anchor point region 27. In this way, the resonant ring can move, and the film layer on a lower surface of the fixed electrode 24 can be segmented conveniently.

Since the fused silica is not conductive, the conductive film layer 25 is deposited on a surface of the resonant ring 23, a surface of the support beam 22 and surfaces of the fixed electrodes 24. According to the gyroscope fabricated in the present disclosure, due to the capacitive gap having the high-steepness structural sidewall and the high-aspect ratio, the conductive film layer with the excellent effect is hardly achieved by a conventional deposition method. In the present disclosure, the conductive film layer 25 is deposited by the ALD. Gas molecules containing film layer elements take place a chemical reaction on a surface of the fused silica repeatedly to deposit atoms layer by layer, realizing growth of the film layer. The ALD has a desirable step coverage capability, and can form a uniformly thick film layer on the outer surface of the structure. Meanwhile, due to all-pervasive gas molecules, for the sidewall of the capacitive gap with the high-aspect ratio, the deposition of the film layer can also be realized. Moreover, the uniformity for the thickness of the film layer is desirable, further ensuring the accuracy of the MEMS gyroscope in the present disclosure. The conductive film layer 25 may be made of oxide or nitride or metal. Further, it may be made of aluminum zinc oxide (AZO) or indium tin oxide (ITO) or titanium nitride (TiN) or platinum (Pt).

In addition, in order to drive the resonant ring 23 in some direction, a conductive region of the structural layer 2 is to be partitioned to form a plurality of independent fixed electrodes 24 that are circumferentially distributed and electrically disconnected, thereby forming effective capacitors with the resonant ring 23. The conductive region is partitioned by femtosecond laser dicing. As shown in FIG. 2, the conductive film layer on an upper surface, a lower surface and one sidewall of each of the suspended fixed electrodes 24 that are connected to the peripheral anchor point region 27 is diced. Specifically, when the conductive film layer is a transparent film layer such as the AZO, the ITO or the TiN, from an upper surface of the MEMS gyroscope, by changing a position of the laser focus on the Z-axis, the film layer at a lower side of the suspended fixed electrode 24 may be segmented. When the conductive film layer is an opaque film layer such as the Pt, from a lower surface of the MEMS gyroscope, the film layer is segmented from one side of the substrate 1 to a lower surface of the suspended fixed electrode 24 with optical transmission characteristics of the fused silica.

In addition, when the fixed electrodes 24 are arranged in the structure in FIG. 5, the conductive film layer on the upper surface, the lower surface and the one sidewall of each of the fixed electrodes 24 that are connected to the peripheral anchor point region 27 is segmented by surface film layer segmentation and stealth dicing. Specifically, after the conductive film layer 25 is deposited on the surface of the resonant ring 23, the surface of the support beam 22 and the surfaces of the fixed electrodes 24 by the ALD, the conductive region is partitioned by the surface film layer segmentation. Then, the fixed electrodes 24 are completely separated from the peripheral anchor point region 27 by the stealth dicing, thereby realizing independent distribution for a plurality of fixed electrodes 24 to form the effective capacitors.

The substrate 1, the resonant ring 23 and the structural layer 2 are made of the same fused silica, so as to prevent the residual stress caused by mismatch in coefficient of thermal expansion, reduce the energy dissipation in vibration, and improve the quality factor of the resonant ring 23. Direct bonding and laser welding are combined for fixing, which can ensure the connection strength, and prevent introduction of additional media. Specifically, two wafers where the structural layer 2 and the substrate 1 are located respectively are attached closely by the direct bonding, so as to meet requirements on weld gaps in the laser welding. During the welding, the two wafers are unnecessarily pressed again, ensuring the uniformity of the gaps, and improving the planeness of the wafers. Then, in a specified region, a joint surface of the structural layer 2 and a joint surface of the substrate 1 are fused integrally by the femtosecond laser welding, so as to achieve the relatively high connection strength, and prevent the unnecessary introduction of additional connection media.

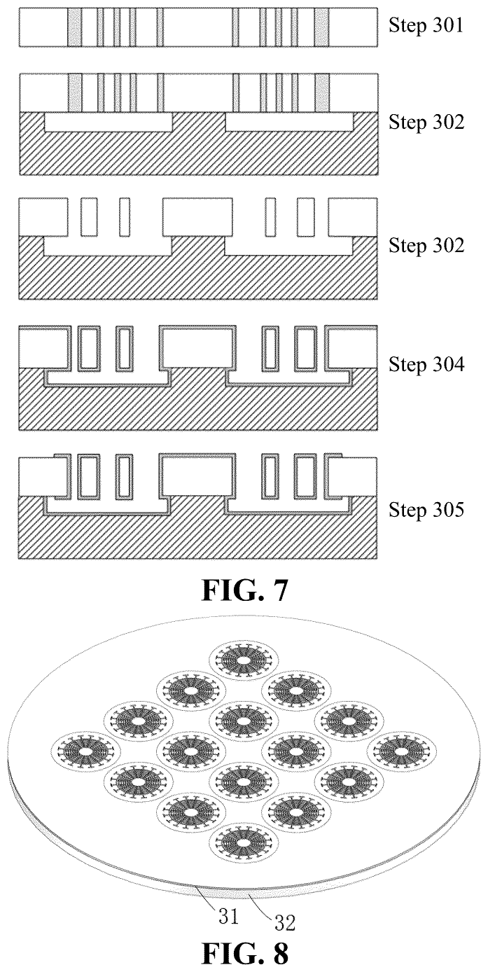

In an embodiment, the design method for all-fused-silica capacitive planarized MEMS gyroscope provided by the present disclosure further includes a fabrication method. Referring to FIG. 7, the fabrication method includes following steps:

Step 301: A fused silica wafer is taken as the structural layer, and contours of the resonant ring, the fixed electrodes, the support beam and the central anchor point on the structural layer are irradiated by laser.

Step 302: Another relatively thick fused silica wafer is taken as the substrate, and a circular recess with the specific size and the boss in the center is formed by wet etching or laser surface dicing or mechanical milling.

Step 303: The structural layer in Step 301 is aligned and attached to the substrate having the circular recess in Step 302. Two wafers are fixed by bonding and laser welding to form an assembly. A lower surface of the central anchor point is fixed to an upper surface of the boss in the center of the recess. The peripheral anchor point region is fixed to the recess periphery. A fixed structure is placed into a hydrofluoric acid solution for wet etching, thereby forming the resonant ring, the fixed electrodes, the honeycomb-like topological support beam, the central anchor point and the capacitive gaps.

Step 304: The conductive film layer is deposited on all outer surfaces and in all gaps of the assembly in Step 303 by the ALD.

Step 305: Junctions between the fixed electrodes and the peripheral anchor point region are sequentially irradiated by the laser. The conductive film layer on the upper surface, the lower surface and the sidewall of each of the fixed electrodes is completely diced, such that the fixed electrodes are electrically disconnected to form a driving electrode and a sensing electrode, thereby completing fabrication of a capacitive fused silica MEMS gyroscope.

Further, a plurality of capacitive fused silica MEMS gyroscopes may be fabricated through structural layer wafer 31 and substrate layer wafer 32 to realize wafer-level mass production. Referring to FIG. 8, in the mass production, different from the fabrication of the single capacitive fused silica MEMS gyroscope, a plurality of resonant rings, a plurality of fixed electrodes, a plurality of support beams and a plurality of central anchor points on the structural layer wafer 31 are irradiated by the laser at the same time in Step 301. A plurality of circular recesses with bosses in centers are formed in the substrate layer wafer 32 in Step 302. Other fabrication steps are the same, and are not repeatedly described herein. Upon completion of Step 305, the fused silica wafer assembly is diced according to an outer contour of the gyroscope to obtain the plurality of capacitive fused silica MEMS gyroscopes.

It should be understood that although the steps in the FIG. 1 of embodiments are sequentially displayed according to the arrows, these steps are not necessarily performed in the order indicated by the arrows. The execution order of these steps is not strictly limited, and these steps may be executed in other orders, unless clearly described otherwise. Moreover, at least some of the steps in FIG. 1 may include a plurality of sub-steps or stages. The sub-steps or stages are not necessarily executed at the same time, but may be executed at different times. The execution order of the sub-steps or stages is not necessarily carried out sequentially, but may be executed alternately with other steps or at least some of the sub-steps or stages of other steps.

The technical characteristics of the above embodiments can be employed in arbitrary combinations. To provide a concise description of these embodiments, all possible combinations of all the technical characteristics of the above embodiments may not be described; however, these combinations of the technical characteristics should be construed as falling within the scope defined by the specification as long as no contradiction occurs.

The above described are merely several embodiments of the present invention. Although these embodiments are described specifically and in detail, they should not be construed as a limitation to the patent scope of the present disclosure. It should be noted that those of ordinary skill in the art can further make several variations and improvements without departing from the concept of the present disclosure, and all of these fall within the protection scope of the present disclosure. Therefore, the protection scope of the present disclosure shall be subject to the appended claims.

What is claimed is:

1. A design method for all-fused-silica capacitive planarized micro electro-mechanical systems (MEMS) gyroscope, applied to design a structure of an MEMS gyroscope, and comprising: determining a configuration of the MEMS gyroscope, comprising a substrate and a structural layer, the structural layer being a planar structure;
forming a recess at one side of the substrate, and providing a boss in a center of the recess;
on the structural layer, providing a central anchor point, a support beam, a resonant ring, fixed electrodes, and a peripheral anchor point region in sequence from the center outward, wherein the central anchor point, the support beam, the resonant ring, the fixed electrodes and the peripheral anchor point region are integrally formed; and forming a capacitive gap having a high-steepness structural sidewall and a high-aspect ratio between the resonant ring and each of the fixed electrodes;
when the substrate and the structural layer are assembled, fixing the boss to the central anchor point, fixing a recess periphery to the peripheral anchor point region, and suspending the support beam and the resonant ring on the recess; and
upon completion of assembly, depositing a conductive film layer on the resonant ring, the support beam and the fixed electrodes by atomic layer deposition (ALD), and segmenting the conductive film layer to form effective capacitors, wherein
the substrate and the structural layer are made of fused silica.

2. The design method for the all-fused-silica capacitive planarized MEMS gyroscope according to claim 1, wherein the support beam is a honeycomb-like topological support beam.

3. The design method for the all-fused-silica capacitive planarized MEMS gyroscope according to claim 2, wherein the central anchor point, the support beam, the resonant ring, the fixed electrodes and the peripheral anchor point region are integrally formed on the structural layer by laser-assisted wet etching.

4. The design method for the all-fused-silica capacitive planarized MEMS gyroscope according to claim 1, wherein the central anchor point is partially suspended on the boss, and the peripheral anchor point region is partially suspended on the recess periphery.

5. The design method for the all-fused-silica capacitive planarized MEMS gyroscope according to claim 4, wherein when the substrate and the structural layer are assembled, direct bonding and laser welding are combined for fixing.

6. The design method for the all-fused-silica capacitive planarized MEMS gyroscope according to claim 1, wherein the depositing the conductive film layer on the resonant ring, the support beam and the fixed electrodes by the ALD, and segmenting the conductive film layer to form the effective capacitors comprises:
depositing the conductive film layer on a surface of the resonant ring, a surface of the support beam and surfaces of the fixed electrodes by the ALD; and
dicing the conductive film layer on an upper surface, a lower surface and one sidewall of each of the fixed electrodes that are connected to the peripheral anchor point region, wherein a plurality of independent fixed electrodes are formed by dicing a surface film layer on the fixed electrodes, wherein the effective capacitors with the resonant ring are formed.

7. The design method for the all-fused-silica capacitive planarized MEMS gyroscope according to claim 1, wherein the depositing the conductive film layer on the resonant ring, the support beam and the fixed electrodes by the ALD, and segmenting the conductive film layer to form the effective capacitors comprises:
depositing the conductive film layer on a surface of the resonant ring, a surface of the support beam and surfaces of the fixed electrodes by the ALD; and
dicing the conductive film layer on an upper surface, a lower surface and one sidewall of each of the fixed electrodes that are connected to the peripheral anchor point region by surface film layer segmentation and stealth dicing, wherein a plurality of independent fixed electrodes are formed by dicing a surface film layer on the fixed electrodes, wherein the effective capacitors with the resonant ring are formed.

8. The design method for the all-fused-silica capacitive planarized MEMS gyroscope according to claim 1, wherein the conductive film layer is made of oxide or nitride or metal.

9. The design method for the all-fused-silica capacitive planarized MEMS gyroscope according to claim 1, further comprising a fabrication method, wherein the fabrication method comprises following steps:
step 301: taking a fused silica wafer as the structural layer, and irradiating contours of the resonant ring, the fixed electrodes, the support beam and the central anchor point on the structural layer by laser;
step 302: taking another relatively thick fused silica wafer as the substrate, and forming, by wet etching or laser surface dicing or mechanical milling, the recess with a predetermined size and the boss in the center;
step 303: aligning and attaching the structural layer in the step 301 to the substrate having the recess in the step 302; fixing two wafers by bonding and laser welding to form an assembly, wherein a lower surface of the central anchor point is fixed to an upper surface of the boss in the center of the recess, and the peripheral anchor point region is fixed to the recess periphery; and placing a fixed structure into a hydrofluoric acid solution for wet etching, wherein the resonant ring, the fixed electrodes, the honeycomb-like topological support beam, the central anchor point and the capacitive gaps are formed;
step 304: depositing the conductive film layer on all outer surfaces and in all gaps of the assembly in the step 303 by the ALD; and
step 305: sequentially irradiating junctions between the fixed electrodes and the peripheral anchor point region by the laser, and completely dicing the conductive film layer on the upper surface, a lower surface and a sidewall of each of the fixed electrodes, wherein the fixed electrodes are electrically disconnected to form a driving electrode and a sensing electrode, wherein fabrication of a capacitive fused silica MEMS gyroscope is completed.

10. The design method for the all-fused-silica capacitive planarized MEMS gyroscope according to claim 2, wherein the central anchor point is partially suspended on the boss, and the peripheral anchor point region is partially suspended on the recess periphery.

11. The design method for the all-fused-silica capacitive planarized MEMS gyroscope according to claim 3, wherein the central anchor point is partially suspended on the boss, and the peripheral anchor point region is partially suspended on the recess periphery.

12. The design method for the all-fused-silica capacitive planarized MEMS gyroscope according to claim 10, wherein when the substrate and the structural layer are assembled, direct bonding and laser welding are combined for fixing.

13. The design method for the all-fused-silica capacitive planarized MEMS gyroscope according to claim 11, wherein when the substrate and the structural layer are assembled, direct bonding and laser welding are combined for fixing.

14. The design method for the all-fused-silica capacitive planarized MEMS gyroscope according to claim 2, wherein the depositing the conductive film layer on the resonant ring, the support beam and the fixed electrodes by the ALD, and segmenting the conductive film layer to form the effective capacitors comprises:
depositing the conductive film layer on a surface of the resonant ring, a surface of the support beam and surfaces of the fixed electrodes by the ALD; and
dicing the conductive film layer on an upper surface, a lower surface and one sidewall of each of the fixed electrodes that are connected to the peripheral anchor point region, wherein a plurality of independent fixed electrodes are formed by dicing a surface film layer on the fixed electrodes, wherein the effective capacitors with the resonant ring are formed.

15. The design method for the all-fused-silica capacitive planarized MEMS gyroscope according to claim 3, wherein the depositing the conductive film layer on the resonant ring, the support beam and the fixed electrodes by the ALD, and segmenting the conductive film layer to form the effective capacitors comprises:
depositing the conductive film layer on a surface of the resonant ring, a surface of the support beam and surfaces of the fixed electrodes by the ALD; and
dicing the conductive film layer on an upper surface, a lower surface and one sidewall of each of the fixed electrodes that are connected to the peripheral anchor point region, wherein a plurality of independent fixed electrodes are formed by dicing a surface film layer on the fixed electrodes, wherein the effective capacitors with the resonant ring are formed.

16. The design method for the all-fused-silica capacitive planarized MEMS gyroscope according to claim 2, wherein the depositing the conductive film layer on the resonant ring, the support beam and the fixed electrodes by the ALD, and segmenting the conductive film layer to form the effective capacitors comprises:
depositing the conductive film layer on a surface of the resonant ring, a surface of the support beam and surfaces of the fixed electrodes by the ALD; and
dicing the conductive film layer on an upper surface, a lower surface and one sidewall of each of the fixed electrodes that are connected to the peripheral anchor point region by surface film layer segmentation and stealth dicing, wherein a plurality of independent fixed electrodes are formed by dicing a surface film layer on the fixed electrodes, wherein the effective capacitors with the resonant ring are formed.

17. The design method for the all-fused-silica capacitive planarized MEMS gyroscope according to claim 3, wherein the depositing the conductive film layer on the resonant ring, the support beam and the fixed electrodes by the ALD, and segmenting the conductive film layer to form the effective capacitors comprises:
depositing the conductive film layer on a surface of the resonant ring, a surface of the support beam and surfaces of the fixed electrodes by the ALD; and
dicing the conductive film layer on an upper surface, a lower surface and one sidewall of each of the fixed electrodes that are connected to the peripheral anchor point region by surface film layer segmentation and stealth dicing, wherein a plurality of independent fixed electrodes are formed by dicing a surface film layer on the fixed electrodes, wherein the effective capacitors with the resonant ring are formed.

18. The design method for the all-fused-silica capacitive planarized MEMS gyroscope according to claim 2, wherein the conductive film layer is made of oxide or nitride or metal.

19. The design method for the all-fused-silica capacitive planarized MEMS gyroscope according to claim 3, wherein the conductive film layer is made of oxide or nitride or metal.
